(19) United States
(12) Patent Application Publication
(10) Pub. No.: US 2014/0123181 A1
(43) Pub. Date: May 1, 2014

(54) Web TV Based Information Browsing Method and System

(71) Applicant: SHENZHEN SKYWORTH-RGB ELECTRONICS CO. LTD., Shenzhen (CN)

(72) Inventors: Zhi-Guo WANG, Shenzhen (CN); Xian-Hui ZENG, Shenzhen (CN); Si-Hua HUANG, Shenzhen (CN); Ni HE, Shenzhen (CN); Zhen-Hui ZHANG, Shenzhen (CN)

(73) Assignee: Shenzhen Skyworth-RGB Electronics Co. Ltd., Shenzhen (CN)

(21) Appl. No.: 13/844,889

(22) Filed: Mar. 16, 2013

(30) Foreign Application Priority Data
Oct. 25, 2012 (CN) 201210413117.3

(51) Int. Cl. H04N 21/472

(52) U.S. Cl. CPC H04N 21/472
USPC 725/37

(57) ABSTRACT

A web TV based information browsing method includes receiving, by a web TV, information on the Internet sent by an information server, classifying the received information, and setting an information tag for the classified information, and displaying, on a display interface currently displayed on the web TV, an information interface for a user to read information corresponding to the information tag with a window according to a size of the display interface, wherein the window is smaller than the display interface. Accordingly, the user can watch TV and read information at the same time, thereby bringing better use experience to users.

### CROSS-REFERENCE TO RELATED APPLICATION

This application claims the priority to Chinese Patent Application No. 201210413117.3, filed in the State Intellectual Property Office of P.R. China, on Oct. 25, 2012, which is hereby incorporated herein in its entirety by reference.

### FIELD OF THE INVENTION

The present invention relates generally to consumer electronics, and more particularly to web TV based information browsing method and system.

### BACKGROUND OF THE INVENTION

With the progress and development of science and technology, the development of TV sets follows the trend of high definition, networking and intelligence. Like smart phones, more and more TV sets are installed with intelligent operating systems. By connecting an intelligent TV to the Internet, unlimited content and services, and complete Internet experience can be provided for users. With the popularity of the Internet, the maturity of cloud technology and the development of intelligent operating system, intelligent TVs are provided with a broadband Internet access capability, and are capable of receiving and playing back data streams such as video and music acquired from the Internet, thus having an Internet communication capability. People are impressed by the large screen and high definition when reading Internet information through an intelligent TV. However, considering the user experience such as operating simplicity and fluency, the current information browsing method of the intelligent TV is not as good as that of other small terminal devices, and the method mainly has the following defects:

1. The interaction is relatively complex. After a website is opened, the screen is full of information and links. When a cursor of a remote controller moves among titles and pictures, it is difficult to locate the cursor at a specific piece of information, and the user may accidentally open web pages of other links due to a misoperation.

2. Much web page information is displayed without being classified. A great deal of information comes at the user, and the classification of the web page information is not clear enough. Important information is mixed with common information, and it is inconvenient to perform a search operation, which makes it difficult for the user to read the information.

3. Tremendous information leads to a low loading speed, and unsmooth operations. With an oversized information amount and too much pictures, the web page is loaded slowly, and the user has to wait a few seconds before the page is open.

4. Web page information is not filtered, and users cannot customize the information classification that they are interested in. To satisfy demands of all aspects, information of a website cannot cater for the interest of each individual user, and therefore the users cannot customize the information classification of interest to them.

5. Users cannot watch TV and browse information at the same time. In a traditional browser, when the information browsing operation is not performed in an analog TV (ATV) or a digital (DTV) mode, the browser is set to a full-screen mode by default. Hence, the user cannot watch TV and browse latest information at the same time.

6. The character font and information window size cannot be customized. A traditional browser does not allow a user to customize the window size and font size, and the background color of the browser is uniformly white and cannot be changed to other comfortable colors such as warm colors. If a user reads at night, the white color is unpleasant.

Therefore, a heretofore unaddressed need exists in the art to address the aforementioned deficiencies and inadequacies.

### SUMMARY OF THE INVENTION

The present invention is directed to web TV based information browsing method and system, which enables a user to watch TV and read latest information at the same time, so as to reduce the time that the user spends on searching for information of interest in tremendous information over the Internet.

In one aspect of the present invention, the method for web TV based information browsing includes receiving, by a web TV, information on the Internet sent by an information server; classifying the received information, and setting an information tag for the classified information; and displaying, on a display interface currently displayed on the web TV, an information interface for a user to read information corresponding to the information tag with a window according to a size of the display interface, wherein the window is smaller than the display interface.

In one embodiment, the method, prior to receiving, by the web TV, the information on the Internet sent by the information server, further comprises searching for the information on the Internet by the information server; sorting the searched information; and sending the sorted information to the web TV in real time.

In one embodiment, the method, prior to receiving, by the web TV, the information on the Internet sent by the information server, further comprises filtering the searched information by the information server according to user customization; and sending the filtered information of interest to the user to the web TV.

In one embodiment, the step of displaying, on a display interface currently displayed on the web TV, an information interface for a user to read information corresponding to the information tag with a window according to a size of the display interface includes adjusting, by the web TV, a size of the information interface and character font and size of the information tag according to preset display parameters; and displaying the information interface with the window at a corresponding position of the display interface currently displayed on the web TV, wherein the window is a translucent floating window smaller than the display interface.

In one embodiment, the method, after displaying, on the display interface currently displayed on the web TV, the information interface for the user to read the information corresponding to the information tag with the window according to a size of the display interface, further comprises receiving, by the web TV, a selection instruction of selecting the information tag from the user; and displaying prompt content of a piece of information corresponding to the currently selected information tag on the information interface, wherein the prompt content at least comprises a tile, a picture and a brief description of the piece of information.

In one aspect of the present invention, the method for web TV based information browsing includes a web TV and an information server.

The web TV is adapted for receiving information on the Internet, classifying the received information, setting an information tag for the classified information, and displaying, on a display interface currently displayed on the web TV, an information interface for a user to read information corresponding to the information tag with a window according to a size of the display interface, wherein the window is smaller than the display interface.

The information server is adapted for sending the information on the Internet to the web TV.

In one embodiment, the information server is further adapted for searching for the information on the Internet by the information server; sorting the searched information; and sending the sorted information to the web TV in real time.

In another embodiment, the information server is further adapted for filtering the searched information by the information server according to user customization; and sending the filtered information of interest to the user to the web TV.

In one embodiment, the web TV includes an adjustment module adapted for adjusting, by the web TV, a size of the information interface and character font and size of the information tag according to preset display parameters; and a first display module adapted for displaying the information interface with the window at a corresponding position of the display interface currently displayed on the web TV, wherein the window is a translucent floating window smaller than the display interface.

In another embodiment, the web TV may further include a second display module, adapted for receiving a selection instruction of selecting the information tag from the user, and displaying prompt content of a piece of information corresponding to the currently selected information tag on the information interface, wherein the prompt content at least comprises a tile, a picture and a brief description of the piece of information.

In another aspect, the present invention relates to a non-transitory tangible computer-readable medium storing instructions which, when executed by one or more processors, cause the above system to perform the method for web TV based information browsing.

According to the present invention, after receiving information on the Internet sent by the information server, the web TV classifies the received information, sets a corresponding information tag for the classified information, and displays on the display interface currently displayed on the web TV, an information interface for the user to read information corresponding to the information tag with a window smaller than the display interface, according to the size of the display interface. Such method of browsing information through the web TV is easy to operate. The user can watch TV and read latest information at the same time, thereby bringing better use experience to users.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a schematic flow chart of an information browsing method based on a web TV according to one embodiment of the present invention;

FIG. 2 is a schematic flow chart of an information browsing method based on a web TV according to another embodiment of the present invention;

FIG. 3 is a schematic flow chart of an information browsing method based on a web TV according to yet another embodiment of the present invention;

FIG. 4 is a schematic flow chart of displaying an information interface in an information browsing method based on a web TV according to one embodiment of the present invention;

FIG. 5 is a schematic flow chart of an information browsing method based on a web TV according to one embodiment of the present invention;

FIG. 6 is a schematic structural view of an information browsing system based on a web TV according to another embodiment of the present invention;

FIG. 7 is a schematic structural block of a web TV in an information browsing system based on a web TV according to one embodiment of the present invention; and

FIG. 8 is a schematic structural view of an information browsing system based on a web TV according to one embodiment of the present invention.

### DETAILED DESCRIPTION OF THE INVENTION

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be adapted for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top”, and “left” and “right”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

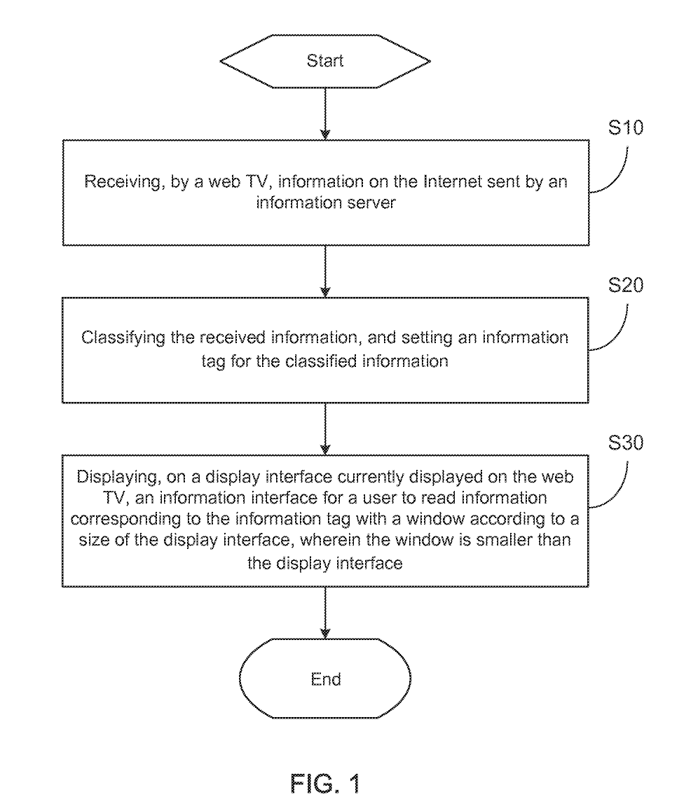

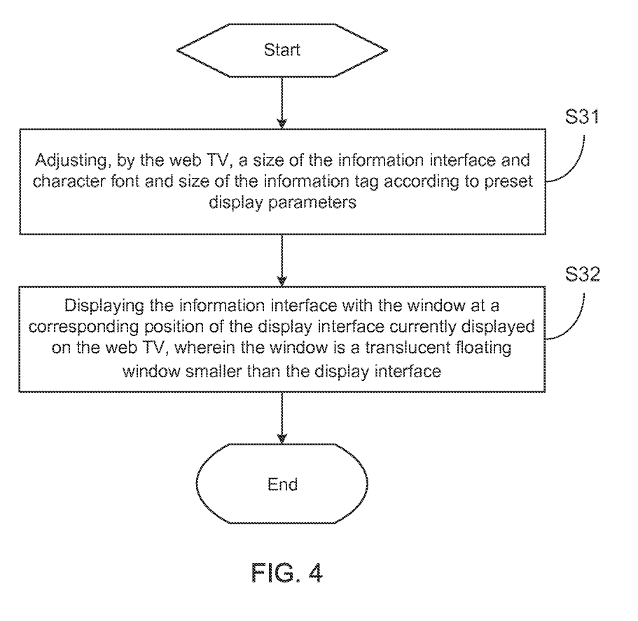

The description will be made as to the embodiments of the present disclosure in conjunction with the accompanying drawings in FIGS. 1-8. It should be understood that specific embodiments described herein are merely adapted for explaining the present invention, but are not intended to limit the present invention. In accordance with the purposes of this disclosure, as embodied and broadly described herein, this invention, in one aspect, relates to an information browsing method based on a web TV, which is capable of displaying an information interface of information on a current TV program interface so that the user can read the information while watching a TV program.

Referring to FIG. 1, a schematic flow chart of an information browsing method based on a web TV is shown according to one embodiment of the present invention. In this embodiment, the information browsing method based on a web TV includes the following steps:

In Step S10, a web TV receives information on the Internet sent by an information server.

In Step S20, the information is classified, and an information tag is set for the classified information.

When the information from the Internet is displayed to a user through the web TV, the information from the Internet is sent through the information server. The web TV receives the information sent by the information server, classifies all the information according to types of content of the information, and then sets a corresponding information tag for the classified information, so as to identify the type of the content of all information under the information tag, so that the user can conveniently choose to read the information from the information tag of interest.

In Step S30, an information interface for a user to read the information corresponding to the information tag is displayed, according to the size of the display interface, and with a window smaller than the display interface, on a display interface currently displayed on the web TV.

When the user selects information to be browsed through a menu of a remote controller and enters an information browsing mode, no matter which mode the web TV is currently in, through a channel of the mode, the information interface formed by the information tag can be directly displayed to the user on the current display interface according to the size of the display interface and with a window smaller than the current display interface. The user can read the information corresponding to the information tag through the information interface without interrupting current use of the web TV. For example, when a TV program that the user is watching enters advertisement time, the user may select an information browsing mode to read information on the interface of the current TV program if the user neither wants to watch advertisement nor wants to miss the TV program.

In one embodiment, after receiving the information on the Internet sent by an information server, the web TV classifies the received information, sets a corresponding information tag for the classified information, and displays on a display interface currently displayed on the web TV, according to the size of the display interface, and with a window smaller than the display interface, an information interface for the user to read the information corresponding to the information tag. Such method of browsing information through a web TV is easy to operate, from which the user can watch TV and read latest information at the same time, thereby bringing better use experience to users.

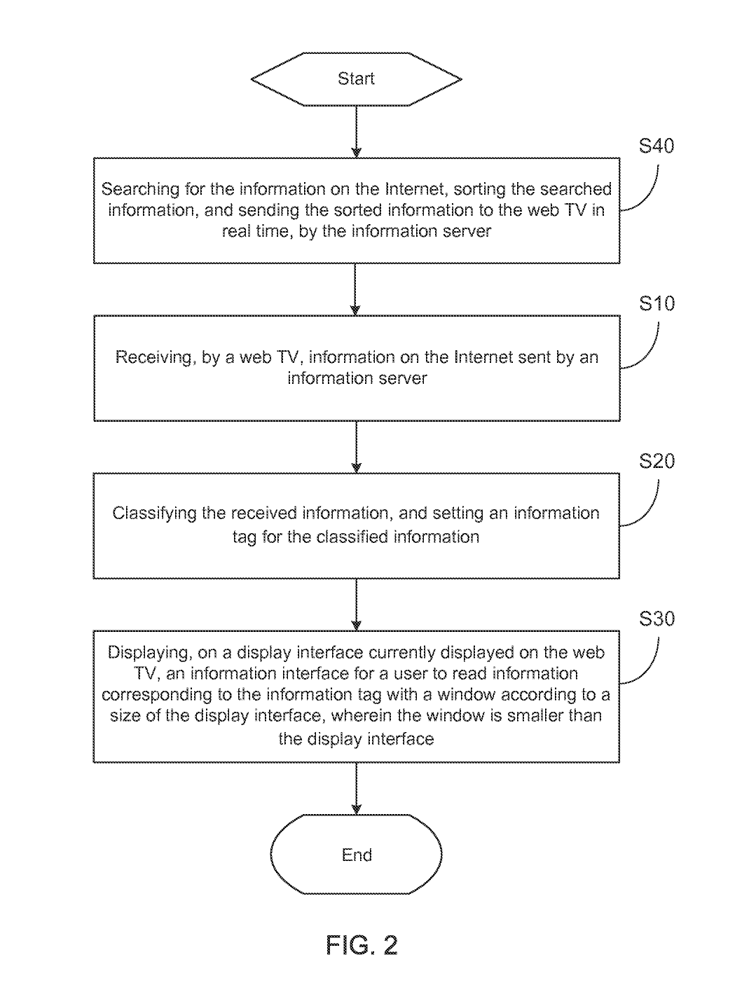

Referring to FIG. 2, a schematic flow chart of an information browsing method based on a web TV is shown according to another embodiment of the present invention.

On the basis of the above embodiment shown in FIG. 1, before Step S10, the information browsing method based on a web TV of the present invention further includes the following step:

In Step S40, the information server searches for information on the Internet, sorts the found/searched information, and sends the sorted information to the web TV in real time.

In this embodiment, when the information on the Internet needs to be displayed to the user, the information server first searches on the Internet, namely, searching for latest hot information, then sorts the found information, namely, filtering out advertisement or useless links and information, and finally sends the sorted information to the web TV in real time.

The information server searches for and sorts information on the Internet, and sends the sorted information to the web TV in real time, thereby ensuring that information data is transmitted efficiently and in real time.

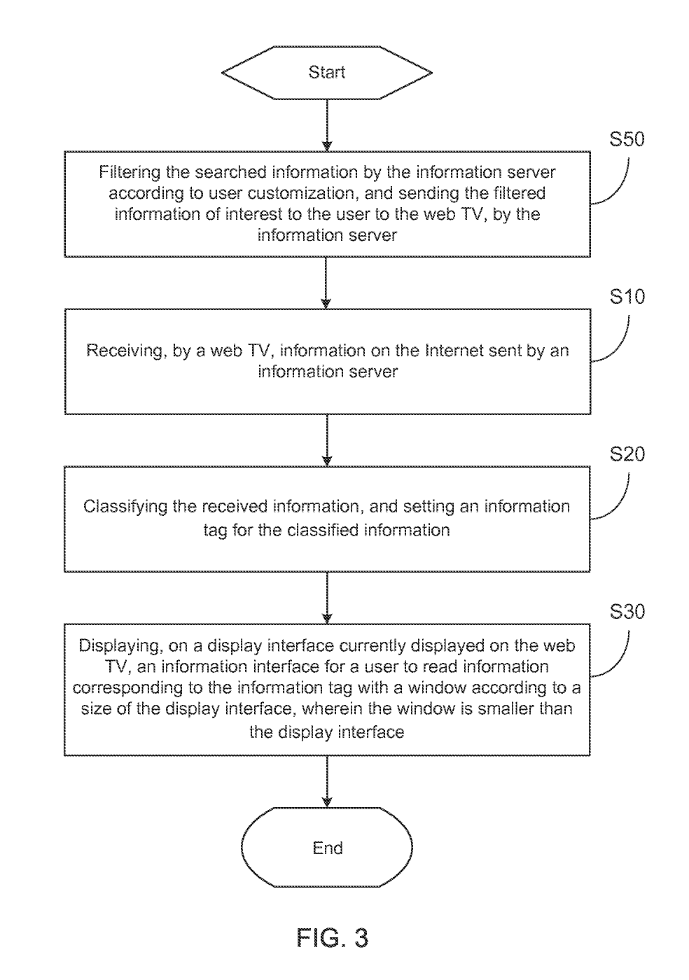

FIG. 3 is a schematic flow chart of an information browsing method based on a web TV according to yet another embodiment of the present invention.

On the basis of the above embodiment shown in FIG. 1, before Step S10, the information browsing method based on a web TV further includes the following step:

In Step S50, the information server filters the found/searched information according to user customization, and sends to the web TV the filtered information of interest to the user.

Before reading the information through the web TV, the user may customize the information type of interest in advance according to a preference. When customizing the type of information, the user may also set preference levels for different information types according to different preference degrees. When finding latest hot information on the Internet, the information server filters the found information according to user customization, namely, filtering out information irrelevant to the type of information customized by the user, and sends to the web TV the filtered information of interest to the user.

After the user customizes the information type of interest according to the preference, the information server finds information, filters the found information according to user customization, and sends to the web TV the filtered information of interest to the user, so that the user can quickly find information of interest within short time, thereby further improving the use experience of the user.

Referring to 4, a schematic flow chart of displaying an information interface in an information browsing method based on a web TV according to one embodiment of the present invention.

In the above embodiments shown in FIGS. 1-3, Step S30 includes the following sub-steps:

In Step S31, the web TV adjusts the size of the information interface and the character font and size of the information tag according to a preset parameter.

In this embodiment, a display parameter may be preset in the web TV, and the display parameter may include the size of the information interface, the character font and size of the information tag and information displayed in the information interface, and whether the information tag and information are displayed in bold or highlighted. To set the size of the information interface is to adaptively generate different sizes of information interface windows according to the resolution of different web TVs, so as to achieve an optimal visual effect and not affect the user in using other functions of the web TV normally. Moreover, parameters such as the character font and size of the information tag and information displayed in the information interface may be set according to the user preference and the size of the information interface. The information interface is displayed based on the set parameters.

In Step S32, with a translucent floating window smaller than the display interface, the information interface is displayed at a corresponding position of the display interface currently displayed on the web TV.

To further ensure that the user can still normally use other functions of the web TV, and can return to the display interface displayed in the current mode in time, the information interface may be translucent. In addition, after the size of the information interface and the character font and size of the information tag are adjusted, the information interface is displayed at a corresponding position of the current display interface with a floating window smaller than the display interface. Moreover, in this embodiment, the theme of the floating window and the background color of the information interface can be customized by the user.

When the information interface is displayed on the current display interface, the size of the information interface, the character font and size of the information tag, and whether the information tag is displayed in bold or highlighted are adjusted according to the preset display parameter, and then the information interface is displayed at the corresponding position on the current display interface with a translucent floating window smaller than the display interface. The display parameter is set flexibly, so as to display the information adaptively, and by using a translucent floating window smaller than the display interface, the information interface can be superposed on the current display interface no matter which mode the web TV is currently in. The user can exit the information interface in any channel, and can switch the interface without entering the information browsing mode.

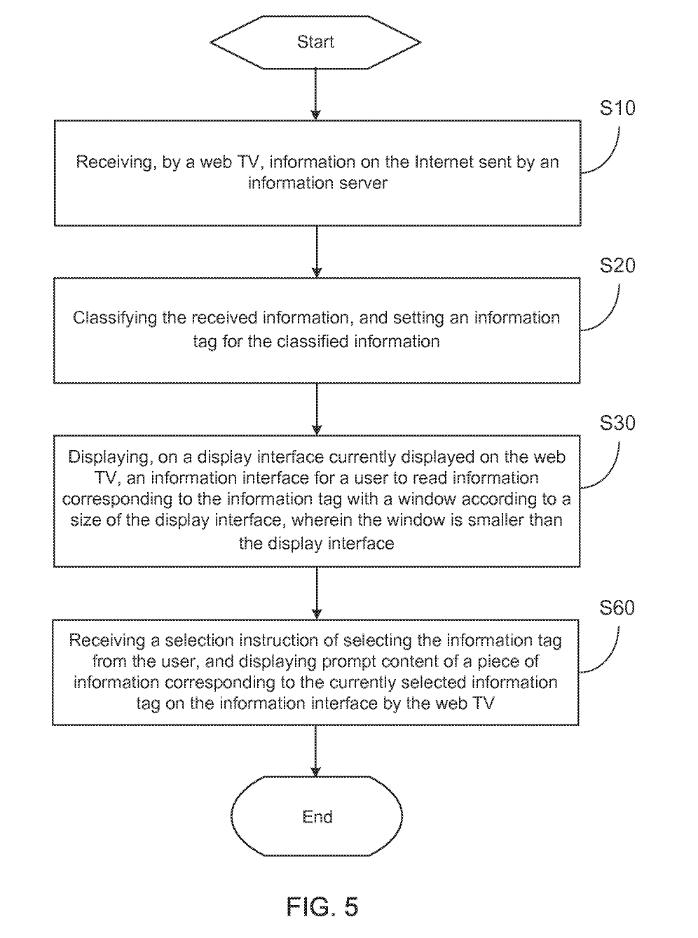

Referring to FIG. 5, a schematic flow chart of an information browsing method based on a web TV according to one embodiment of the present invention.

On the basis of the above embodiments shown in FIGS. 1-3, after Step S30, the information browsing method based on a web TV further includes the following step:

In Step S60, the web TV receives a selection instruction of selecting an information tag from the user, and displays on the information interface prompt content of a piece of information corresponding to the currently selected information tag, the prompt content at least including a tile, a picture and brief description of the piece of information.

After displaying the information interface on the current display interface, the user may select a corresponding information tag in the information interface through a remote controller according to an actual requirement, and at this time, a selection instruction is sent to the web TV. After receiving the selection instruction, the web TV displays on the information interface the prompt content of a piece of information corresponding to the currently selected information tag. The selected piece of information is usually the most important piece of information under the information tag, and the prompt content includes prompt information such as the title, picture and brief description of the information, so that the user can conveniently determine whether to read this piece of information according to the prompt content.

Meanwhile, on the information interface, the user can select different information tags through the remote controller, and after the current information tag is selected, the user can further choose the prompt content of the information through the remote controller. For example, the information tag can be selected through the left button and right button of the remote controller, while the prompt content of the information can be selected through the upper button and lower button of the remote controller.

After receiving the selection instruction of selecting the current information tag from the user, the web TV displays on the information interface prompt content such as the title, picture and brief description of the most important piece of information under the currently selected information tag. Each page loads only one piece of information each time, so the loading of the page is smoother, and the user waits shorter time.

In another aspect, the present invention also provides an information browsing system based on a web TV. The system includes a web TV and an information server.

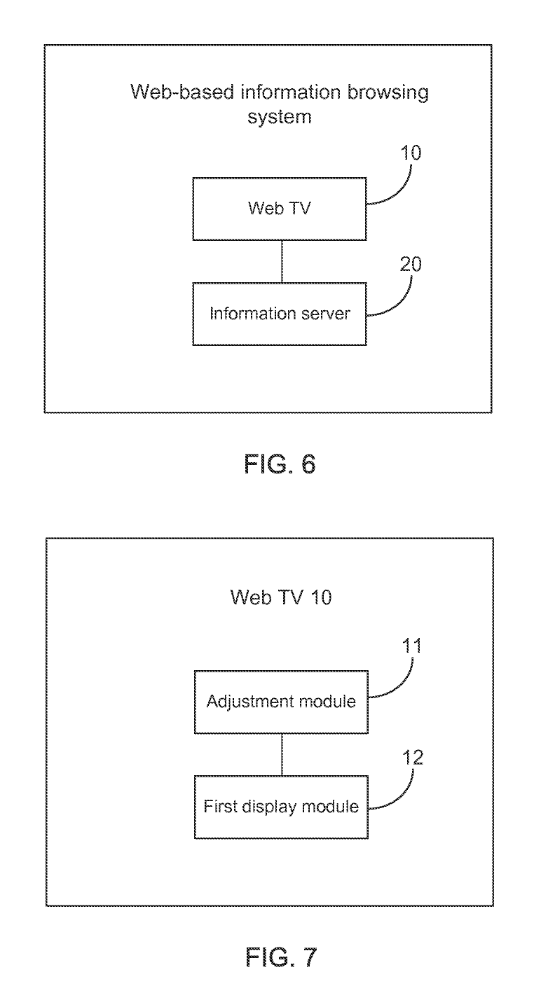

Referring to FIG. 6, a schematic structural block of an information browsing system based on a web TV is shown according to one embodiment of the present invention. In the exemplary embodiment, the web TV based information browsing system includes a web TV 10 and an information server 20.

The web TV 10 is adapted for receiving information on the Internet sent by the information server; classifying the information, and setting a corresponding information tag for the classified information; and displaying, on a display interface currently displayed on the web TV, according to the size of the display interface, and with a window smaller than the display interface, an information interface for a user to read information corresponding to the information tag.

The information server 20 is adapted for sending information on the Internet to the web TV.

When information from the Internet is displayed to a user through the web TV 10, the information from the Internet is sent through the information server 20. The information server 20 is adapted for sending information on the Internet to the web TV 10. The web TV 10 receives the information sent by the information server 20, classifies all the information according to types of content of the information, and then sets a corresponding information tag for the classified information, so as to identify the type of the content of all information under the information tag, so that the user can conveniently choose to read information from an information tag of interest.

When the user selects information to be browsed through a menu of a remote controller and enters an information browsing mode, no matter which the web TV 10 is currently in, through a channel of the mode, the information interface formed by the information tag can be directly displayed to the user on the current display interface according to the size of the display interface and with a window smaller than the current display interface. The user can read the information corresponding to the information tag through the information interface without interrupting current use of the web TV 10. For example, when a TV program that the user is watching enters advertisement time, the user may select an information browsing mode to read information on the interface of the current TV program if the user neither wants to watch advertisement nor wants to miss the TV program.

In one embodiment, after receiving information on the Internet sent by an information server, the web TV 10 classifies the received information, sets a corresponding information tag for the classified information, and displays, on a display interface currently displayed on the web TV 10, an information interface for a user to read information corresponding to the information tag with a window according to a size of the display interface, wherein the window is smaller than the display interface. Such web TV based information browsing system is easy to operate, where the user can watch TV and read latest information at the same time, thereby bringing better use experience to users.

In one embodiment, the information server 20 is further adapted for searching for information on the Internet, sorting found information, and sending the sorted information to the web TV 10 in real time.

In the exemplary embodiment, when the information on the Internet needs to be displayed to the user, the information server 20 first searches on the Internet, namely, searching for latest hot information, then sorts the found information, namely, filtering out advertisement or useless links and information, and finally sends the sorted information to the web TV 10 in real time. The information server 20 searches for and sorts information on the Internet, and sends the sorted information to the web TV 10 in real time, thereby ensuring that information data is transmitted efficiently and in real time.

In another embodiment, the information server 20 is further adapted for filtering the found information according to user customization, and sending to the web TV the filtered information of interest to the user.

Before reading the information through the web TV 10, a user may customize the information type of interest in advance according to a preference. When customizing the information type, the user may also set preference levels for different information types according to different preference degrees. When finding latest hot information on the Internet, the information server 20 filters the found information according to user customization, namely, filtering out information irrelevant to the type of information customized by the user, and sends the filtered information of interest to the user to the web TV 10.

After the user customizes the information type of interest according to the preference, the information server finds information, filters the found information according to user customization, and sends the filtered information of interest to the user to the web TV 10, so that the user can quickly find information of interest within short time, thereby further improving the use experience of the user.

Referring to FIG. 7, a schematic structural block of a web TV utilized in a web TV based information browsing system is shown according to one embodiment of the present invention. In this embodiment, the web TV 10 includes an adjustment module 11, adapted for adjusting the size of the information interface and the character font and size of the information tag according to a preset display parameter; and a first display module 12, adapted for displaying, with a translucent floating window smaller than the display interface, the information interface at a corresponding position of the display interface currently displayed on the web TV.

In one embodiment, a display parameter may be preset in the web TV 10, and the display parameter may include the size of the information interface, the character font and size of the information tag and information displayed in the information interface, and whether the information tag and information are displayed in bold or highlighted. To set the size of the information interface is to adaptively generate different sizes of information interface windows according to the resolution of different web TVs, so as to achieve an optimal visual effect and not affect the user in using other functions of the web TV 10 normally. Moreover, parameters such as the character font and size of the information tag and information displayed in the information interface may be set according to the user preference and the size of the information interface. The information interface is displayed based on the set parameters.

To further ensure that the user can still normally use other functions of the web TV 10, and can return to the display interface displayed in the current mode in time, the information interface may be translucent. In addition, after the size of the information interface and the character font and size of the information tag are adjusted, the information interface is displayed at a corresponding position of the current display interface with a floating window smaller than the display interface. Moreover, in this embodiment, the theme of the floating window and the background color of the information interface can be customized by the user.

When the information interface is displayed on the current display interface, the size of the information interface, the character font and size of the information tag, and whether the information tag is displayed in bold or highlighted are adjusted according to the preset display parameter, and then the information interface is displayed at the corresponding position on the current display interface with a translucent floating window smaller than the display interface. The display parameter is set flexibly, so as to display the information adaptively, and by using a translucent floating window smaller than the display interface, the information interface can be superposed on the current display interface no matter which mode the web TV is currently in; the user can exit the information interface in any channel, and can switch the interface without entering the information browsing mode.

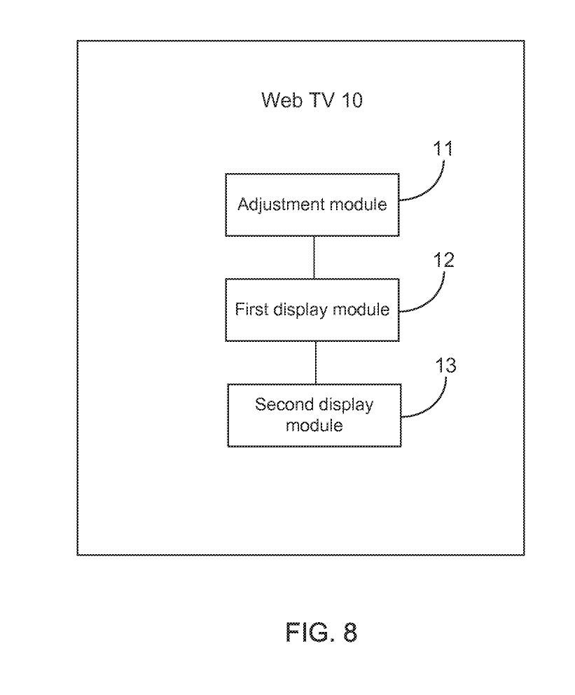

Referring to FIG. 8, a schematic structural block of an information browsing system based on a web TV according to another embodiment of the present invention.

In this embodiment, the web TV 10, in addition to the adjustment module 11 and the first display module 12 shown in FIG. 7, further includes a second display module 13 that is adapted for receiving a selection instruction of selecting an information tag from the user, and displaying on the information interface prompt content of a piece of information corresponding to the currently selected information tag, the prompt content at least including a tile, a picture and brief description of the piece of information.

After displaying the information interface on the current display interface, the user may select a corresponding information tag in the information interface through a remote controller according to an actual requirement, and at this time, a selection instruction is sent to the web TV. After receiving the selection instruction, the web TV displays, through the second display module 13, on the information interface the prompt content of a piece of information corresponding to the currently selected information tag. The selected piece of information is usually the most important piece of information under the information tag, and the prompt content includes prompt information such as the title, picture and brief description of the information, so that the user can conveniently determine whether to read this piece of information according to the prompt content.

Meanwhile, on the information interface, the user can select different information tags through the remote controller, and after the current information tag is selected, the user can further choose the prompt content of the information through the remote controller. For example, the information tag can be selected through the left button and right button of the remote controller, while the prompt content of the information can be selected through the upper button and lower button of the remote controller.

After receiving the selection instruction of selecting the current information tag from the user, the web TV displays on the information interface prompt content such as the title, picture and brief description of the most important piece of information under the currently selected information tag. Each page loads only one piece of information each time, so the loading of the page is smoother, and the user waits shorter time.

The methods described above may be implemented by one or more computer programs executed by one or more processors. One aspect of the present invention provides a non-transitory tangible computer-readable medium storing instructions which, when executed by the one or more processors, cause the above disclosed system to perform the above-disclosed method for web TV based information browsing. The computer programs may also include stored data. Non-limiting examples of the non-transitory tangible computer readable medium are nonvolatile memory, magnetic storage, and optical storage. The storage medium may include, for example, CD/DVD, Read-Only Memory or ROM, and Random Access Memory or RAM, a magnetic disk, an optical disk, flash dive, or the likes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for web television (TV) based information browsing, comprising:
receiving, by a web TV, information on the Internet sent by an information server;
classifying the received information, and setting an information tag for the classified information; and
displaying, on a display interface currently displayed on the web TV, an information interface for a user to read information corresponding to the information tag with a window according to a size of the display interface, wherein the window is smaller than the display interface.

2. The method according to claim 1, prior to receiving, by the web TV, the information on the Internet sent by the information server, further comprising:
searching for the information on the Internet by the information server.

3. The method according to claim 2, prior to receiving, by the web TV, the information on the Internet sent by the information server, further comprising:
sorting the searched information; and
sending the sorted information to the web TV in real time.

4. The method according to claim 2, prior to receiving, by the web TV, the information on the Internet sent by the information server, further comprising:
filtering the searched information by the information server according to user customization; and
sending the filtered information of interest to the user to the web TV.

5. The method according to claim 4, wherein the displaying step comprises:
adjusting, by the web TV, a size of the information interface and character font and size of the information tag according to preset display parameters; and
displaying the information interface with the window at a corresponding position of the display interface currently displayed on the web TV, wherein the window is a translucent floating window smaller than the display interface.

6. The method according to claim 1, after displaying, on the display interface currently displayed on the web TV, the information interface for the user to read the information corresponding to the information tag with the window according to a size of the display interface, further comprising:
receiving, by the web TV, a selection instruction of selecting the information tag from the user; and
displaying prompt content of a piece of information corresponding to the currently selected information tag on the information interface, wherein the prompt content at least comprises a tile, a picture and a brief description of the piece of information.

7. A system for web television (TV) based information browsing, comprising:
a web TV, adapted for receiving information on the Internet, classifying the received information, setting an information tag for the classified information, and displaying, on a display interface currently displayed on the web TV, an information interface for a user to read information corresponding to the information tag with a window according to a size of the display interface, wherein the window is smaller than the display interface; and
an information server, adapted for sending the information on the Internet to the web TV.

8. The system according to claim 7, wherein the information server is further adapted for:
searching for the information on the Internet by the information server.

9. The system according to claim 8, wherein the information server is further adapted for:
sorting the searched information; and
sending the sorted information to the web TV in real time.

10. The system according to claim 8, wherein the information server is further adapted for:
filtering the searched information by the information server according to user customization; and
sending the filtered information of interest to the user to the web TV.

11. The system according to claim 10, wherein the web TV comprises:
an adjustment module, adapted for adjusting, by the web TV, a size of the information interface and character font and size of the information tag according to preset display parameters; and
a first display module, adapted for displaying the information interface with the window at a corresponding position of the display interface currently displayed on the web TV, wherein the window is a translucent floating window smaller than the display interface.

12. The system according claim 7, wherein the web TV further comprises:
a second display module, adapted for receiving a selection instruction of selecting the information tag from the user, and displaying prompt content of a piece of information corresponding to the currently selected information tag on the information interface, wherein the prompt content at least comprises a tile, a picture and a brief description of the piece of information.

13. A non-transitory tangible computer-readable medium storing instructions which, when executed by one or more processors, cause a system to perform a method for web TV based information browsing, the method comprising:
receiving, by a web TV, information on the Internet sent by an information server;
classifying the received information, and setting an information tag for the classified information; and
displaying, on a display interface currently displayed on the web TV, an information interface for a user to read information corresponding to the information tag with a window according to a size of the display interface, wherein the window is smaller than the display interface.

14. The non-transitory tangible computer-readable medium according to claim 13, wherein the method, prior to receiving, by the web TV, the information on the Internet sent by the information server, further comprises:
searching for the information on the Internet by the information server.

15. The non-transitory tangible computer-readable medium according to claim 14, wherein the method, prior to receiving, by the web TV, the information on the Internet sent by the information server, further comprises:
sorting the searched information; and
sending the sorted information to the web TV in real time.

16. The non-transitory tangible computer-readable medium according to claim 14, wherein the method, prior to receiving, by the web TV, the information on the Internet sent by the information server, further comprises:
filtering the searched information by the information server according to user customization; and
sending the filtered information of interest to the user to the web TV.

17. The non-transitory tangible computer-readable medium according to claim 16, wherein the displaying step comprises:
adjusting, by the web TV, a size of the information interface and character font and size of the information tag according to preset display parameters; and
displaying the information interface with the window at a corresponding position of the display interface currently displayed on the web TV, wherein the window is a translucent floating window smaller than the display interface.

18. The non-transitory tangible computer-readable medium according to claim 13, wherein the method, after displaying, on the display interface currently displayed on the web TV, the information interface for the user to read the information corresponding to the information tag with the window according to a size of the display interface, further comprises:
receiving, by the web TV, a selection instruction of selecting the information tag from the user; and
displaying prompt content of a piece of information corresponding to the currently selected information tag on the information interface, wherein the prompt content at least comprises a tile, a picture and a brief description of the piece of information.
